(19) United States
(12) Patent Application Publication
(10) Pub. No.: US 2004/0163507 A1
(43) Pub. Date: Aug. 26, 2004

(54) Punch holder and storage tool

(76) Inventor: Mark A. Voves, Cresco, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/786,687

(22) Filed: Feb. 25, 2004

Related U.S. Application Data
(60) Provisional application No. 60/450,442, filed on Feb. 26, 2003.

(51) Int. Cl. B25H 3/00

(52) U.S. Cl. 81/487

(57) ABSTRACT

A punch holder with an elongated handle with an enclosed compartment at one end. The enclosed compartment is frusto-shaped having a flat headed end, tapered side walls, and additionally has a plunger that is associated with a spring that yieldingly urges the plunger into the closed compartment. The elongated hollow handle also has a side handle secured to one end of the plunger and slidably disposed within the hollow handle such that the side handle can be used to control the plunger so that a punch may be inserted through the compartment and held in place by the plunger.

### CROSS REFERENCE TO A RELATED APPLICATION

This application is based upon Applicants' Provisional Application Serial No. 60/450,442 filed Feb. 26, 2003.

### BACKGROUND OF THE INVENTION

Hammer driven punches or chisels are common tools used around machinery or in woodworking. If the punch is held in one hand and the hammer in the other, even the most experienced person will occasionally hit the punch head with a glancing blow whereupon the hammer will be deflected and strike the holding hand. This is usually a painful and sometimes an injurious experience.

Also, it is often unhandy for the worker to have a plurality of punches of different sizes on his person to address the task at hand.

It is therefore a principal object of this invention to provide a punch holder and storage tool which can easily hold the driven punch by one hand at a safe distance from the hammer.

A further object of the invention is to provide a punch holder and storage tool wherein punches of different sizes can be selectively loaded into the tool.

A still further object of the invention is to provide a punch holder and storage tool which can carry a plurality of punches or chisels without interfering with the punch driving operation.

These and other objects will be apparent to those skilled in the art.

### BRIEF SUMMARY OF THE INVENTION

The present invention is a punch holder that will hold a punch or another tool away from the hand when hammering it with a hammer. The punch holder has an elongated handle with an enclosed compartment that is frusto-shaped with a flat head and tapered side walls that receive the punch. Also within this compartment is a plunger that is slidably within the handle and spring loaded such that the plunger will hold the punch against the frusto-shaped walls of the compartment. The plunger is controlled by a handle that will slide up and down thus permitting a punch to be placed through the compartment. Additionally, the handle of the punch holder can be hollowed to store punches.

### BRIEF DESCRIPTION OF THE DRAWINGS

FIG. 1 is an exploded perspective view of the plunger assembly;

FIG. 2 is an enlarged scale partial sectional view of the tool body; and

FIG. 3 is a partial sectional view similar to that of FIG. 1 with a punch inserted therein.

### DESCRIPTION OF THE PREFERRED EMBODIMENTS OF THE INVENTION

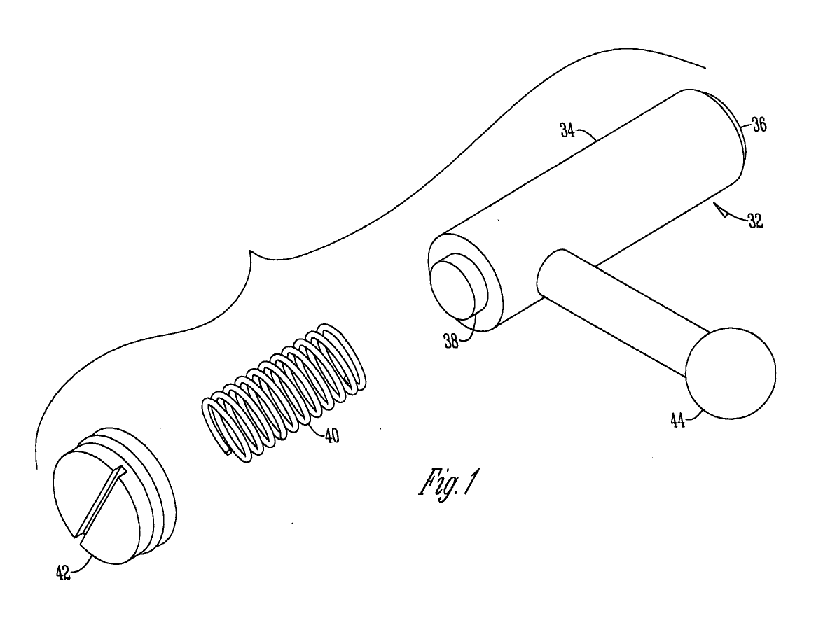

With reference to FIGS. 1-3, the numeral 10 designates the tool comprised of a cylindrical body 12 with a forward end 14 and a rearward end 16. The forward end has a frusto-shaped compartment 18 having a flat head 20, and tapered side walls 22 to accommodate the hexagonal shape of the shank of a chisel 24.

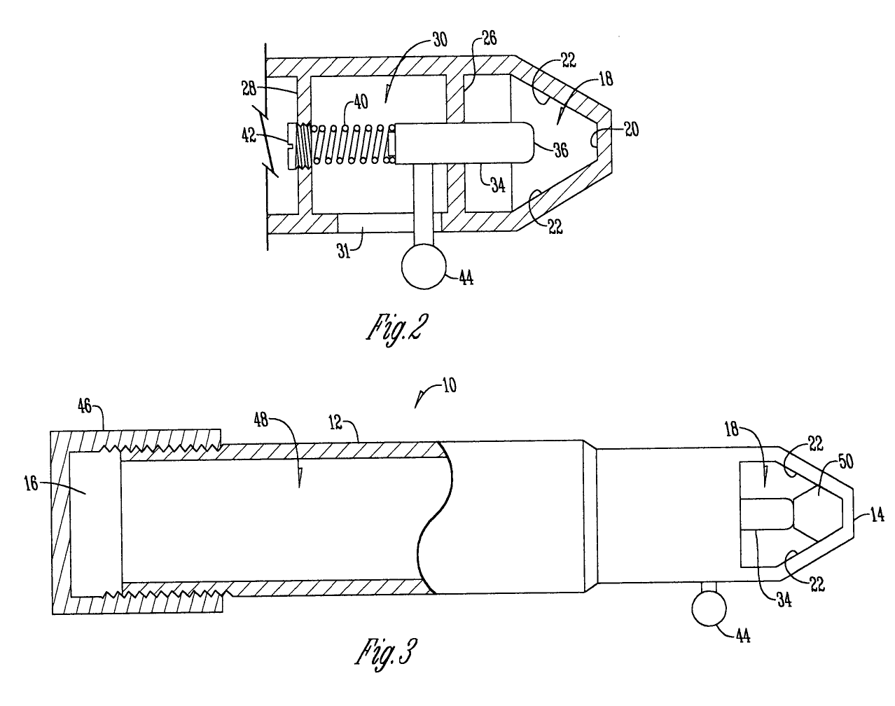

The body 12 has transverse walls 26 and 28 (FIG. 2). Wall 26 forms the bottom of compartment 18, and the two walls define a further compartment 30. An elongated slot 31 is formed in one side of compartment 30.

A plunger assembly 32 (FIG. 1) comprises an elongated plunger 34 slidably mounted in a center aperture of wall 26 with a forward end 36 extending into compartment 18. A rearward end 38 of reduced diameter extends into compartment 30 and receives one end of compression spring 40. The other end of spring 40 engages threaded plug 42 (FIG. 2) which is used to adjust the compression of spring 40. A handle 44 extends laterally outwardly of compartment 30 through slot 31 (FIG. 2).

A friction cap 46 closes the inner end 16 of body 12 to close storage compartment 48 which can be used to store a plurality of chisels or punches 50.

In operation, the handle 44 is pulled rearwardly to permit a punch to be positioned as shown in FIG. 2 within compartment 18. The handle 44 is then released, and spring 40 pushes plunger 34 forwardly so that its forward end 36 engages the punch 50 and binds it against surfaces 20 and 22. With the chisel being held the operator can hold the tool 10 by grasping housing 12, and can use the other hand to strike a hammer on the chisel. The compartment 48 can be used to store a plurality of punches or chisels, with access being via removable cap 46.

It is therefore seen that this invention will achieve all of its objectives.

What is claimed is:

1. A punch holder, comprising,
an elongated hollow handle having a forward end with an enclosed compartment having a shape to receive and engage the shank of an elongated punch,
a plunger slidably mounted in the handle and having a forward end in the enclosed compartment,
a spring associated with the plunger yieldingly urging the plunger into the enclosed compartment,
an elongated slot in the handle, and
a handle secured by one end to the plunger and extending outwardly through the slot to permit manual grasping thereof to pull the plunger rearwardly against the spring to release a punch shank from engagement with the plunger, or to permit the placement of a punch within the enclosed compartment in the path of a forward end of the plunger.

2. The device of claim 1 wherein a storage compartment is provided in the handle for receiving a plurality of punches.

3. The punch holder of claim 1 wherein the enclosed compartment is frusto-shaped having a flat head and tapered side walls.
